(19) United States
(12) Patent Application Publication
(10) Pub. No.: US 2018/0268393 A1
(43) Pub. Date: Sep. 20, 2018

(54) SALES MANAGEMENT SYSTEM HAVING I/O BOX

(71) Applicant: TRUSTED SOLUTIONS CORPORATION, NEW TAIPEI CITY (TW)

(72) Inventor: Kuang Hung CHENG, NEW TAIPEI CITY (TW)

(21) Appl. No.: 15/893,270

(22) Filed: Feb. 9, 2018

(30) Foreign Application Priority Data
Mar. 20, 2017 (TW) 106109141

(51) Int. Cl. G06Q 20/20; G07G 1/14; G06F 13/10

(52) U.S. Cl. CPC G06Q 20/202; G06F 13/102; G07G 1/14

(57) ABSTRACT

A sales management system having an I/O box is provided. The sales management system is electrically connected with peripheral devices and includes a host, an I/O box, peripheral devices, and a cloud server. The cloud server is provided with a web-based web POS system. The host is communicated with the cloud server via a network device. A browser of the host serves as an interface to operate and execute the web-based POS system of the cloud server. Wherein, the I/O box receives an instruction of the web-based POS system to operate one of the peripheral devices, and the I/O box executes the instruction through a driver corresponding to the peripheral device. Through the I/O box, the sales management system can control the peripheral devices with ease. There is no need to install the drivers of various peripherals devises, having the advantage of a cross-platform operating system.

### FIELD OF THE INVENTION

The present invention relates to a sales management system, and more particularly to a sales management system having an I/O box (input/output box).

### BACKGROUND OF THE INVENTION

In order to enhance operational efficiency and reduce the probability of human errors, the process managements of most restaurants, catering services, supermarkets, logistics industry and other industry are electronized as the main trend of development. Through reliable information management equipment and program applications, the cost can be reduced and the management is effective, thereby improving the efficiency of the process managements of enterprises. Thus, how to effectively use the advantages of speediness and low error rate of electronization and information is a major topic for the management, and the use of a POS system becomes the key point of success and failure.

For the user of a POS (Point of Sale) system 92, as shown in FIG. 1, a personal computer 91 having the POS system 92 and a peripheral device 94, such as a barcode scanner, a credit card reader, a printer, and the like, related to the POS system 92 are required. The POS system 92 stores the relevant data in a cloud server 93. However, for some hosts, such as mobile phones and tablets, there is no electrical connection port for peripheral devices of the personal computers, which may make it difficult to electrically connect and operate these peripheral devices.

Therefore, how to overcome the shortcomings of the POS system is a topic for the industry to improve the POS system.

Accordingly, the inventor of the present invention has devoted himself based on his many years of practical experiences to solve these problems and develop a sales management system having an I/O box (input/output box). The sales management system not only enables some hosts, such as mobile phones and tablet PCs, to easily connect and operate these peripheral devices, but also can be performed on different operating systems to effectively increase the efficiency and flexibility of using the POS system to serve the community and facilitate the development of the industry.

### SUMMARY OF THE INVENTION

The primary object of the present invention is to provide a sales management system having an I/O box (input/output box). Through the I/O box, the sales management system can control various electrically connected peripheral devices with ease. There is no need to install the drivers of various peripherals devises, and there is no need to have electrical ports for electrically connecting various peripheral devices. The sales management system has the advantage of a cross-platform operating system.

In order to achieve the aforesaid object, the sales management system of the present invention is electrically connected with peripheral devices. The sales management system comprises a host, an I/O box (input/output box), and a cloud server. The host includes a browser and a network device. The I/O box has a control board. The control board is provided with electrically connected electronic components, a plurality of peripheral device electrical ports, and a plurality of peripheral device drivers. The I/O box is coupled to the host in a wired or wireless manner. The cloud server is provided with a web-based web POS system. The host is communicated with the cloud server via the network device. The browser of the host serves as an interface to operate and execute the web-based POS system of the cloud server. Wherein, the I/O box receives an instruction of the web-based POS system to operate one of the peripheral devices, and the I/O box executes the instruction through the driver corresponding to the peripheral device.

Preferably, the browser of the host operates and executes the web-based POS system of the cloud server and immediately stores input data, output data and an operation result in the cloud server.

Preferably, the host is one of a desktop computer, a notebook computer, a tablet computer, and a mobile phone.

Preferably, the peripheral devices are one of a printer, a bar code scanner, a magnetic card reader, a credit card reader, a cash drawer, an invoice machinery, a screen, a keyboard and a stylus, or a combination thereof.

Preferably, the peripheral devices are coupled to the I/O box in a wired or wireless manner.

Preferably, the electronic components are microprocessors and memories.

### BRIEF DESCRIPTION OF THE DRAWINGS

FIG. 1 is a block diagram of a conventional POS system; and

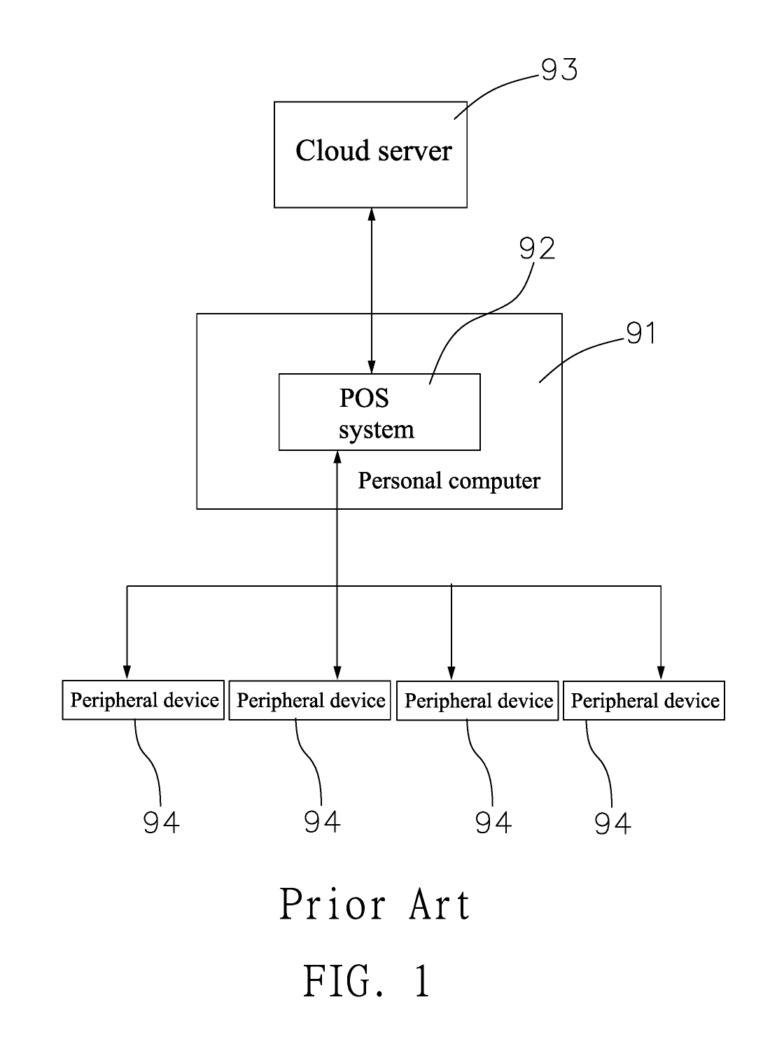

FIG. 2 is a block diagram of a sales management system in accordance with the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

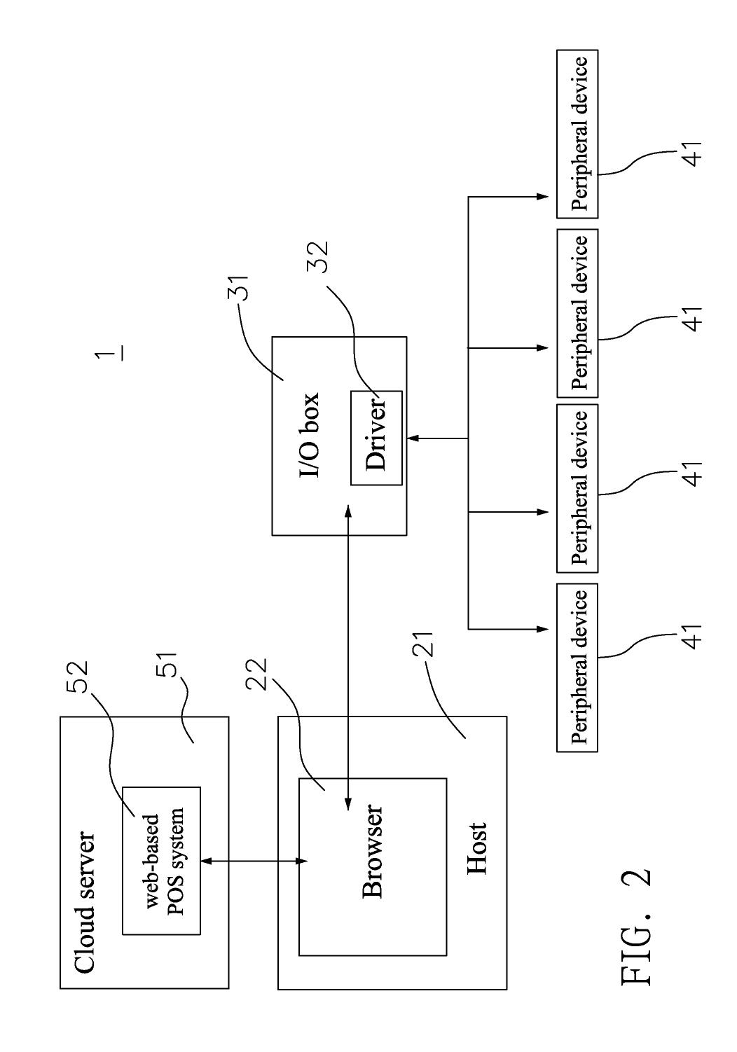

FIG. 2 illustrates a block diagram of a sales management system having an I/O box (input/output box) in accordance with the present invention. The sales management system comprises a host 21, an I/O box 31, and a cloud server 51.

The host 21 includes a browser 22 and a network device (not shown in the figures).

The I/O box 31 has a control board, a plurality of peripheral device electrical ports (not shown in the figures), and a plurality of peripheral device drivers 32. The I/O box 31 is coupled to the host 21 in a wired or wireless manner.

The cloud server 51 is provided with a web-based POS system 52. The host 21 is communicated with the cloud server 51 via the network device. The browser 22 of the host 21 serves as an interface to operate and execute the web-based POS system 52 of the cloud server 51.

The control board is provided with electrically connected electronic components, such as microprocessors and memories.

Wherein, the I/O box 31 is coupled with a plurality of peripheral devices 41 in a wired or wireless manner.

Wherein, the I/O box 31 receives an instruction of the web-based POS system 52 to operate one of the peripheral devices 41. The I/O box 31 executes the instruction through the driver 32 corresponding to the peripheral device 41.

The web-based POS system 52 is a software written in a web language. The web language is a program language, such as HTML, JavaScript, Java, and the like. An application written in this web language is operated and executed with the browser 22 as an interface. It is not limited by an operating system, that is, it can be executed by Windows, Mac, Linux, iOS and other operating systems to achieve the use of a cross-platform.

The host 21 may be a desktop computer, a notebook computer, a tablet computer, a mobile phone, or any host which is able to execute the operation of the browser 22.

The web-based POS system 52 executes the operations, such as, sales, cash register, printing invoices and receipts, and so on, and provides inventory schedules of retail stores/sales counters/franchise stores, daily sales schedules of retail stores/sales counters, sales statistics of members, commodity daily sales statistics of retail stores/sales counters, monthly sales statistics of retail stores/sales counters, time interval sales statistics, sales statistics of commodity time interval. The aforesaid is only an example. The actual functions of the web-based POS system 52 are not limited to the aforesaid.

As to the web-based POS system 52, the user can click the link point of the web-based POS system 52 through the browser 22 of the host 21, that is, the browser 22 serves as an interface to execute all the functions of the web-based POS system 52. The user does not need to download the software of the POS system, does not need to install the POS system, and does not need to upgrade and update the web-based POS system 52. It is very simple for the user to use the system. There is no burden of maintenance.

The peripheral devices 41 may be one of a printer, a bar code scanner, a magnetic card reader, a credit card reader, a cash drawer, an invoice machinery, a screen, a keyboard and a stylus or a combination thereof, but not limited to the aforesaid.

When the web-based POS system 52 operates one of the peripheral devices 41, the host 21 controls the peripheral device 41 through the I/O box 31. Therefore, the host 21 can control the peripheral device 41 without the driver 32 of the peripheral device 41 and the electrical port of the peripheral device 41.

The browser 22 of the host 21 can operate and execute the web-based POS system 52 of the cloud server 51 and immediately store input data, output data and the result of the operation in the cloud server. This way not only reduces the hardware condition and the operational load of the host 21 but also forms big data through the data stored in the cloud server 51, including sales data of each region, each store, each time interval and various customer preferences. In addition, the big data can be further analyzed and compiled to get valuable trend information.

The web-based software has the advantage of a cross-platform operating system. However, the POS system needs to use a variety of peripheral equipment, such as a bar code scanner, a magnetic card reader, a credit card reader, a cash drawer, an invoice machinery, etc. The web-based software operated on the browser is unable to directly control the peripheral equipment connected with the host in which the browser is located, so most of the conventional POS systems are application software directly executed in the operating system, with various drivers of the operating system to control the corresponding peripheral equipment. Therefore, the host executing the POS system needs to be installed and set with a variety of drivers and electrical ports so that the host is limited to the above requirements, and the POS system doesn't have the advantage of a cross-platform operating system.

The system solves the above problem by providing the I/O box 31. For example, when the user operates the I/O box 31 to print an invoice, the I/O box 31 receives an instruction to print an invoice, and one of the peripheral devices 41 executes the instruction of printing an invoice through the corresponding driver 32 and an electrical connection interface (such as a USB port, an RS-232 port, a Bluetooth transmission interface, and the like) electrically connected to the peripheral device 41. When the printing of the invoice is completed, the execution result of the peripheral device 41 is returned to the web-based POS system 52 to let the user know that the printing of the invoice has been completed.

From the above description, it can be seen that the system has the following advantages: the host 21 of the system requires relatively simple conditions, for example, a mobile phone or a tablet computer can be used as the host 21 of the system, there is no need to install the drivers of various peripherals devises, and there is no need to have electrical ports for electrically connecting various peripheral devices. Only the I/O box 31 is provided to control the peripheral devices 41, having the advantage of a cross-platform operating system.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A sales management system, electrically connected with peripheral devices, comprising:
a host, including a browser and a network device;
an I/O box (input/output box), having a control board, the control board being provided with electrically connected electronic components, a plurality of peripheral device electrical ports and a plurality of peripheral device drivers, the I/O box being coupled to the host in a wired or wireless manner;
a cloud server, provided with a web-based POS (Point of Sale) system, the host being communicated with the cloud server via the network device, the browser of the host serving as an interface to operate and execute the web-based POS system of the cloud server;
wherein, the I/O box receives an instruction of the web-based POS system to operate one of the peripheral devices, and the I/O box executes the instruction through the driver corresponding to the peripheral device.

2. The sales management system as claimed in claim 1, wherein the browser of the host operates and executes the web-based POS system of the cloud server and immediately stores input data, output data and an operation result in the cloud server.

3. The sales management system as claimed in claim 1, wherein the host is one of a desktop computer, a notebook computer, a tablet computer, and a mobile phone.

4. The sales management system as claimed in claim 1, wherein the peripheral devices are one of a printer, a bar code scanner, a magnetic card reader, a credit card reader, a cash drawer, an invoice machinery, a screen, a keyboard and a stylus, or a combination thereof.

5. The sales management system as claimed in claim 1, wherein the peripheral devices are coupled to the I/O box in a wired or wireless manner.

6. The sales management system as claimed in claim 1, wherein the electronic components are microprocessors and memories.
